(19) United States
(12) Patent Application Publication
(10) Pub. No.: US 2024/0016183 A1
(43) Pub. Date: Jan. 18, 2024

(54) MEAT-ANALOGUE COMPOSITION AND PROCESS FOR THE PREPARATION THEREOF

(71) Applicant: AAK AB, Malmo (SE)

(72) Inventor: Jeroen DEMEURISSE, Malmo (SE)

(21) Appl. No.: 18/029,968

(22) PCT Filed: Oct. 21, 2021
(86) PCT No.: PCT/SE2021/051057

§ 371 Date: Apr. 3, 2023

(30) Foreign Application Priority Data
Oct. 21, 2020 (SE) 2030316-0

(51) Int. Cl. A23J 3/22; A23J 3/14; A23J 3/16; A23L 29/10; A23L 29/262; A23L 29/212; A23L 29/30; A23D 7/005; A23D 7/04; A23D 7/01

(52) U.S. Cl. CPC A23J 3/227; A23J 3/14; A23J 3/16; A23L 29/10; A23L 29/262; A23L 29/212; A23L 29/30; A23D 7/0053; A23D 7/04; A23D 7/011

(57) ABSTRACT

The present invention relates to a meat-analogue composition comprising an oil-in-water structured emulsion and plant protein, a process for preparing the meat-analogue composition, and the use of an oil-in-water structured emulsion in a meat-analogue composition. The structured emulsion, which may comprise a polyhydroxy compound, is characterized by an ordered lamellar gel network and is useful for retaining the moisture and fat content in the meat-analogue upon cooking, obviating use of saturated fatty acids and trans fatty acids.

The present invention relates to a meat-analogue composition comprising an oil-in-water structured emulsion and plant protein, a process for preparing the meat-analogue composition, and the use of an oil-in-water structured emulsion in a meat-analogue composition, particularly for retaining the moisture and fat content in the meat-analogue upon cooking and obviating use of saturated fatty acids and trans fatty acids in such compositions. The structured emulsion may also comprise a polyhydroxy compound.

### BACKGROUND

There is an increasing demand for plant-based foods due to consumer's increasing desire to eat healthy, sustainably sourced food products and to generally lower their meat intake. This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of sizzling and browning during cooking, bleeding, colour, texture and taste. One example of such meat-analogues is plant-based burgers.

The typical composition of known meat-analogues is 50 to 60% water, 10 to 25% proteins (such as soy, pea, potato and wheat), 5 to 20% fat (such as coconut, palm, sunflower, rapeseed), 0 to 10% carbohydrates, as well as flavourings and colourings. However, during the cooking process of these meat-analogues, significant amounts of water and oil are often lost, resulting in a dry food product with an unappealing texture. In order to produce a desirable meat-analogue, it is important that the final product have an appealing taste, texture and mouthfeel. In particular, it is desirable to retain oil and water in order to achieve a food product with a ‘juicy’ (less dry) texture.

The retention of moisture can be aided by the gelling of water in the product. This has historically been achieved by using egg white proteins. However, these are not suitable for vegan foods. Hydrocolloids showing this thermo-gelling functionality are the cellulosic products methylcellulose (MC) and hydroxypropyl methylcellulose (HPMC). MC is almost always used as a vegan alternative to egg white.

An example of an emulsion using MC is provided in US 2005/0003071, which describes a process for making a plant-based meat-analogue, which comprises an emulsion containing water, oil, methylcellulose, vegetable protein, modified starch, modified gluten and flavourings. This emulsion is added to a final composition of plant-based patties to decrease weight losses during cooking.

However, both MC and egg white only bind moisture and do not prevent oil losses upon cooking. Moreover, many products on the market containing MC still lose significant amounts of moisture during cooking/frying as well. WO 2017/172718 describes a method of improving one or more of the properties of a food composition selected from cohesion, firmness, juiciness, freeze thaw stability, texture, resistance to shrinking during cooking, or boil-out control. This involves incorporating into the composition a combination of okara or whole soy or a mixture thereof, and a fiber-containing pectin product or pectin.

Proposed solutions in the prior art often involve the use of complex combinations of proteins, hydrocolloids and modified starches to properly bind moisture, but these may not address the problem of oil loss during cooking. It has also been found that in some compositions aimed at preventing oil and moisture loss, the resulting meat-analogue products were not juicy despite losing little moisture and oil. Without being bound by theory, it is considered that in such compositions, the moisture and oil is bound too strongly, resulting in a lack of juiciness in the final product.

Additionally, emulsions based on MC and/or proteins often exhibit gelled behaviour prior to being incorporated into a food product, making them difficult to handle. This can make it difficult to incorporate these emulsions into the food product in the desired amount.

Furthermore, oils and fats high in saturated fatty acids are used for conferring desirable texture and structure to food products. However, their use in meat-analogue compositions can be insufficient for binding the oil content, resulting in an undesirable consistency. Additionally, as a greater understanding of the negative health impacts of saturated fatty acids has developed, it has become increasingly desirable to reduce their prevalence in food products.

There remains a need for improved methods of achieving desirable texture and consistency in meat-analogue food products and avoiding moisture and fat losses on cooking. Preferably, such methods also reduce or eliminate the use of saturated and trans fatty acids, and increase stability and shelf-life.

### SUMMARY OF THE INVENTION

It has now been found that oil and moisture losses associated with the cooking of meat-analogue compositions can be reduced, by incorporating a structured oil-in-water emulsion into the meat-analogue composition. Furthermore, it has been surprisingly found that the presence of such an emulsion in a meat-analogue composition results in a desirable texture and consistency in cooked food products obtainable therefrom.

Thus, in a first aspect, the present invention provides a meat-analogue composition comprising an oil-in-water structured emulsion and plant protein; wherein said structured emulsion is characterised by an ordered lamellar gel network. In some embodiments, this structured emulsion further comprises a polyhydroxy compound.

In a second aspect, the present invention provides a process for preparing a meat-analogue composition, said process comprising the step of: forming the meat-analogue composition by blending a plant protein with an oil-in-water structured emulsion characterised by having an ordered lamellar gel network. In some embodiments, the process further comprises the step of: preparing the plant protein by providing a dry phase comprising plant protein and blending the dry phase with an amount of water. In some embodiments, the oil-in-water structured emulsion comprises a polyhydroxy compound.

In another aspect, the present invention provides a meat-analogue composition preparable, or prepared, by the process described herein.

In a further aspect, the present invention provides the use of a structured emulsion as defined herein as a component of a meat-analogue composition, for instance for reducing oil and/or water loss from the meat-analogue composition during cooking.

### DETAILED DESCRIPTION

### Meat-Analogue Composition

The meat-analogue composition of the present invention has been found to exhibit improved properties over known compositions, particularly in terms of “juiciness”, which has historically been hampered by oil and/or moisture losses during cooking. The meat-analogue composition of the present invention avoids weight loss as well as unwanted shrinkage during frying/cooking. In addition, the composition exhibits a juicy texture and desirable consistency once cooked, and may also be prepared with desirable springiness, cohesiveness, hardness, gumminess, chewiness, resilience and adhesiveness. Moreover, the meat-analogue composition of the present invention may be prepared with low levels of saturated fatty acids and also with a low content of contaminants, such as mineral oil saturated hydrocarbons and mineral oil aromatic hydrocarbons typically associated with the use of coconut oil, which is often used in known meat-analogue compositions.

The meat-analogue composition of the present invention comprises a plant protein. The plant protein may suitably be present in an amount of from 2 to 50 wt. % of the composition. In preferred embodiments, the plant protein is present in an amount from 5 to 30 wt. %, more preferably from 15 to 25 wt. % of the composition.

Plant protein is a source of protein which is obtained or derived from plants. The plant protein may be any suitable plant protein and may comprise a mixture of plant proteins and/or may include protein isolates or concentrates. Examples of suitable plant proteins include algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. Preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10-20 wt. % of protein. Typically, when hydrated TVPs can contain up to 3 to 4 times their dry weight in water.

The plant protein used in the preparation of the meat-analogue composition may be either dry (also referred to as ‘dry phase’ herein) or moist. Thus, in embodiments, the plant protein may be included in a dry mix of ingredients, which may include additional ingredients intended for inclusion in the meat-analogue composition, such as carbohydrates, fibre and/or hydrocolloids, in addition to protein. If the plant protein is dry, it may be hydrated prior to and/or during the formation of the meat-analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the a_{w} of the dry phase is 0.90 or lower, more preferably below 0.80. The dry phase comprising plant protein is typically provided in a substantially dehydrated state to reduce microbial growth as far as possible so as to extend shelf life.

The meat-analogue composition may comprise a carbohydrate. The carbohydrate may be any edible form of carbohydrate, including for example starch, flour, edible fibre, or combinations thereof. The carbohydrate is suitably present in an amount of at least 0.01 wt. %, preferably at least 0.05 wt. %, more preferably at least 1 wt. %, and most preferably at least 5 wt. % of the composition. The carbohydrate is suitably present in an amount of up to 20 wt. %, preferably up to 15 wt. %, more preferably up to 12 wt. % and most preferably up to 10 wt. % of the composition. In embodiments, the carbohydrate is present in an amount of at least 0.01 wt. %, preferably from 0.05 to 15 wt. %, more preferably from 5 to 10 wt. % of the composition.

The meat-analogue composition comprises water, which may derive from the structured emulsion component of the composition, as well as additional sources of water added separately in the preparation of the composition. The amount of water is not particularly limited and, as the skilled person will appreciate, will vary depending on the intended consistency of the meat-analogue composition. Suitably the meat-analogue composition may comprise from 35 to 70 wt. % water, preferably from 40 to 65 wt. % water. For the avoidance of doubt, reference to the water content for the composition includes the water contained in the structured emulsion component of the composition.

A meat-analogue composition may further comprise one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya. In preferred embodiments, the meat-analogue composition is free, or substantially free, of polysaccharides and/or modified polysaccharides.

The meat-analogue composition may further comprise a polyhydroxy compound, preferably with a molecular weight of 500 g/mol or less. In preferred embodiments, this polyhydroxy compound forms part of, or is otherwise associated with, the structured emulsion, although it is envisaged that this compound alternatively or additionally may be present elsewhere in the composition. The polyhydroxy compound is discussed in greater detail below.

The meat-analogue composition of the invention may further comprise one or more optional additives used to modify organoleptic, storage and other properties, example of which include milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators.

Amino acids are a preferred additive for the meat-analogue compositions of the invention, since these are known to contribute to the Maillard reaction, a form of non-enzymatic browning resulting from the chemical reaction between amino acids and sugars upon heating. This is used in flavour development of cooked foods and this reaction can be used in the meat-analogue composition to replicate the taste of meat by creating savoury meaty flavours.

### Structured Emulsion

The term ‘structured emulsion’ used herein is intended to refer to an oil-in-water emulsion that exhibits a mesophase in the form of an ordered lamellar gel network. The architecture of the structured emulsion means that the composition may be considered to be solid or semi-solid. The structured emulsion exhibits advantageous stability, meaning that the structured emulsion can exist as a solid or semi-solid over a wide range of temperatures, for example up to temperatures of 100° C., 110° C. and even up to 125° C.

In examples, the structured emulsion has: i) a storage modulus, G′, which is greater than its loss modulus, G″, which parameters are derived from complex shear modulus, G* (Pa), and phase-shift angle, δ, typically assessed as part of a vector diagram defining visco-elasticity, and ii) tan δ=G″/G′<1. These parameters may be readily determined by known methods for evaluating time-dependent viscoelastic behaviour (for example using oscillatory tests performed with shearing under constant dynamic-mechanical conditions) or for evaluating temperature-dependent viscoelastic behaviour (for example by exposing the structured emulsion to a frequency sweep, where preferably the storage modulus, G′, is constant over the frequency range of from 1 to 5 Hz). The skilled person is aware of rheometer apparatuses that may be used for measuring storage and loss modulus, for instance rheometers from Anton Paar (e.g. MCR300).

Suitable structured emulsions for use in the present invention also include those disclosed in WO 2005/107489, which describes cellular solid matrices comprising structured oil and aqueous phases and their preparation, and WO 2014/043778, which describes oil in water structured emulsions comprising waxes and surfactants.

The oil-in-water structured emulsion may comprise one or more of a non-ionic emulsifier and an ionic emulsifier and may, in preferred embodiments, additionally include a polyhydroxy compound. Thus, in some embodiments of the present invention, the structured emulsion comprises, based on the weight of the structured emulsion, the following:
i) from 1 to 8 wt. % emulsifier;
ii) from 12 to 40 wt. % water; and
iii) from 25 to 70 wt. % oil.

In preferred embodiments, the oil-in-water structured emulsion may further comprise, based on the weight of the structured emulsion:
iv) from 1 to 55 wt. % of polyhydroxy compound.

Preferably, the polyhydroxy compound has a molecular weight of 500 g/mol or less. Optionally, the polyhydroxy compound contains vicinal hydroxyl groups.

The structured emulsion may comprise one or more waxes in addition or as an alternative to the polyhydroxy compound. The wax may be present in an amount of 0.01-15% wax by weight of the structured emulsion. Without being bound by theory, waxes are thought to provide structure to the emulsion, for example, to increase stress yield and elastic modulus, of the emulsion. Therefore, waxes may stabilise the emulsion.

The above combination of components and their relative proportions in the structured emulsion have been found to be particularly useful in providing a structured emulsion which readily forms upon mixing of oil and aqueous phases and exhibits a high stability and long shelf-life. The inclusion of a polyhydroxy compound in the emulsion has been found to promote or enhance the formation and retention of a structured emulsion with particular structural or morphological features which give rise to heightened stability, which includes unprecedented heat stability.

Structured emulsions according to the present invention include those having alpha gel or beta gel phase structures. Preferably, the structured emulsions of the present invention have an alpha gel phase structure, in favour of the more thermodynamically favourable beta gel phase (‘coagel’). A mesomorphic change in the structured emulsion from the alpha gel phase to the beta gel phase can result in oil and/or water loss from the respective phases, which can be undesirable for maintaining the texture and consistency of the structured emulsion and of food products comprising it (e.g. as a result of oil/water migration). However, a high stability alpha gel phase may be formed in the structured emulsions used in the meat-analogue composition of the present invention, which have been shown to resist mesomorphic changes over much longer time periods. This results in low oil and/or water loss (e.g. as a result of oil/water migration) and thus imparts good texture and consistency to food products comprising the meat-analogue composition.

At low temperature, the sub-alpha gel phase can exist (typically between 7° C. and 13° C.). The sub-alpha gel phase is known to undergo a thermally induced transition to the alpha gel phase at higher temperature, typically above 13° C. The presence of sub-alpha gel phase at low temperature is therefore an indicator of the stable existence of the alpha gel phase at higher temperature. In the structured emulsions used in the meat-analogue composition of the present invention, there has been found to be strong retention of the sub-alpha gel phase at low storage temperatures, after 55 days and even longer following formation of the structured emulsion. This therefore indicates that, at higher temperatures, the alpha gel phase of these structured emulsions will advantageously exist over a long time period.

The stability exhibited by the structured emulsion, particularly when comprising a polyhydroxy compound, includes stability to mesomorphic change (and consequential oil and/or water loss from the structured emulsion) over time, but also unexpectedly stability with respect to heating and also to the presence of salt in the emulsion. For instance, the structured emulsion may, for example, contain up to 1.5 wt. % even up to 2.0 wt. % of sodium chloride, without any negative impact on structural stability. Furthermore, the inventors have found in experiments that these structured emulsions can readily withstand heating at, for example, between 80° C. and 100° C. for 30 minutes. The improved tolerance of the structured emulsion to the presence of salt enabled by the polyhydroxy compound may also allow salt to be used as a bacteriostatic, thereby increasing microbial shelf-life.

It is believed to be possible to modify the extent of the stability conferred to the structured emulsion by modifying the concentration of the polyhydroxy compound present therein. Thus, by modifying the amount of polyhydroxy compound included in the structured emulsion, it is believed to be possible to change the temperature to which the structured emulsion may be heated, whilst remaining stable. As will be appreciated, concentrations of polyhydroxy compound at the upper end of the range described herein will result in higher heat stability than lower concentrations This can be a particular advantage in controlling the nature of the meat-analogue composition in response to extended periods of storage, and of course cooking.

When a meat-analogue composition is exposed to typical cooking temperatures, at least a portion of the structured emulsion is expected to breakdown as the limit of its heat stability is exceeded, particularly toward the outer surface of the meat-analogue composition where temperatures during cooking are highest. By controlling the degree of stability conferred to the structured emulsion by adjusting the concentration of polyhydroxy compound, the degree the structured emulsion may be expected to break across the thickness of the meat-analogue composition (i.e. across the temperature gradient typically established during cooking) may change. In some embodiments, less polyhydroxy compound may be incorporated into the structured emulsion, meaning that the structured emulsion is expected to break at lower temperatures such that the oil and water components of the emulsion may be released on cooking to a greater extent giving rise to what is perceived to be a juicier product following cooking.

In embodiments, the structured emulsion is preferably stable under storage conditions, for example, at temperatures below 30° C., such as below 20° C., below 10° C., or below 0° C., when incorporated into the meat-analogue composition. In embodiments, the structured emulsion is not fully stable to cooking temperatures (i.e. at least a portion of the structure emulsion breaks down at the cooking temperature over the cooking time period), when incorporated into the meat-analogue composition. For example, at least a portion of the structured emulsion, when incorporated into the meat-analogue composition, breaks down at cooking temperatures of above 70° C., above 80° C., above 100° C. or above 150° C., such as at temperatures from 70° C. to 240° C., 80° C. to 220° C., 100 to 210° C. or 150 to 200° C. Preferably, during cooking, the internal temperature of the meat-analogue composition will be at a temperature of at least 70° C., preferably at least 75° C.

Without being bound by theory, it is believed that desirable texture properties are attained in the cooked food product when the structured emulsion is in the alpha phase at storage temperatures and is partially converted to the beta gel phase at cooking temperatures, because this results in oil and/or water loss from the structured emulsion upon cooking but not upon storage. This is believed to result in a juicy cooked food product.

In embodiments, the amount of polyhydroxy compound may be selected in order to achieve a structured emulsion which is stable at storage temperatures, but which breaks down at cooking temperatures, as disused hereinabove. It is believed that modifying the polyhydroxy compound concentration over the range of 1 to 55 wt. % of the weight of the structured emulsion, excellent storage stability can be achieved, whilst also allowing for partial breakdown of the structured emulsion (when incorporated into the meat analogue composition) at cooking temperatures, resulting in a desirable texture in the final cooked food product.

The concentration of sub-alpha gel phase in the structured emulsion may be based on melting enthalpy. For example, the structured emulsions may be analyzed by Differential Scanning Calorimetry (DSC) to identify the presence of a melting peak at 7-13° C., which is characteristic of the sub-alpha gel phase. The melting enthalpy (J/g) and peak temperature (° C.) for this peak over time may be used to determine the stability of the sub-alpha gel phase, with a reduction in the melting enthalpy of this peak indicating a loss of the sub-alpha and alpha gel phase. Methods of measurement of this parameter would be known to the skilled person.

X-ray scattering patterns may also be used to assess molecular organisation in the emulsion. In particular, the samples may be assessed in the wide angle region (WAXS) and the change in the peak observed over time. If the WAXS pattern remains the same, this indicates that no change in the molecular organisation of the emulsion has occurred. For example, structured emulsions have been found to exhibit a single characteristic peak with an associated d-spacing of ˜4.2 Å. However unstable emulsions which exhibited a shift from the alpha-gel phase to the coagel (beta-gel) phase showed changes in the WAXS pattern which manifested as a depression in this peak.

For example, X-ray scattering patterns of the structured emulsions may be collected in the range of 1°<2θ<8° and 16°<2θ<24°, at a rate of 0.1°/min using a Rigaku MultiFlex powder X-ray diffractometer outfitted with a copper X-ray tube (Cu-K α1, λ=1.5418 Å) operating at 40 kV and 44 mA. Preferably, the apparatus is set with a 0.5° divergence slit, 0.5° scattering slit, and a 0.3 mm receiving slit and analysis is performed by spreading the sample on a circular-welled aluminium slide, which serves as the sample holder in the XRD apparatus. Preferably, data acquisition is performed at room temperature (20° C.).

The structured emulsion used in the present invention may be prepared without recourse to preservation techniques commonly relied upon for improving microbial shelf-life, and which do not satisfy ‘clean label’ requirements. As these structured emulsions have been found to exhibit an unprecedented level of stability, they have been found to be particularly suitable for incorporating into a meat-analogue composition according to the present invention, in particular a meat-analogue composition for cooking. As a result of the stability of the structured emulsion, it is possible to reliably prepare food products containing the emulsion which have consistent properties and performance. The structured emulsions described herein may, for instance, be relied upon for oil binding purposes in the meat-analogue composition of the present invention, in addition to providing desirable texture and consistency.

### Polyhydroxy Compound

The meat-analogue composition may comprise a polyhydroxy compound. Preferably, the structured emulsion comprises at least a portion of the polyhydroxy compound and/or the structured emulsion of the composition is prepared in the presence of a polyhydroxy compound. The meat-analogue composition, preferably the structured emulsion, may comprise more than one polyhydroxy compound.

Reference herein to a polyhydroxy compound refers to a compound having at least two hydroxyl (—OH) groups on an aliphatic hydrocarbyl ring or chain, and which is suitable for food applications and therefore incorporation into the meat-analogue composition of the invention. The polyhydroxy compound may have a molecular weight of 500 g/mol or less, preferably 400 g/mol or less, and more preferably 350 g/mol or less. The polyhydroxy compound may have a molecular weight of at least 100 g/mol, preferably at least 120 g/mol, and more preferably at least 140 g/mol.

The polyhydroxy compound comprises at least two hydroxyl groups, and preferably between 3 and 10 hydroxyl groups, more preferably between 5 and 8 hydroxyl groups. In preferred embodiments, the polyhydroxy compound comprises at least two vicinal hydroxyl groups (i.e. where two hydroxyl groups are bonded to adjacent carbon atoms in the hydrocarbyl ring or chain). Without being bound by any particular theory, it is believed that the presence of vicinal hydroxyl groups in the polyhydroxy compound may be of particular benefit for enhancing the stability of the structured emulsion and such an arrangement may be more capable, sterically, of forming favourable interactions within the structured emulsion as a result.

The term “hydrocarbyl” as used herein, refers to a monovalent or divalent group, preferably a monovalent group, comprising a major proportion of hydrogen and carbon atoms, preferably consisting exclusively of hydrogen and carbon atoms, which group may be unsaturated aliphatic or preferably saturated aliphatic. Examples include alkyl and alkenyl groups. The hydrocarbyl group may be optionally substituted by one or more groups, in addition to the at least two hydroxyl groups; these optional additional substituents are preferably selected from carboxylic acid groups, C₁ to C₄ alkoxy, C₂ to C₈ alkoxyalkoxy, C₃ to C₆ cycloalkyl, —CO₂(C₁ to C₆)alkyl, and —OC(O)(C₁ to C₆)alkyl. Additionally or alternatively, one or more of the carbon atoms of the hydrocarbyl, and any substituents attached thereto, of the hydrocarbyl group may be replaced with an oxygen atom (—O—), provided that the oxygen atom is not bonded to another heteroatom. The hydrocarbyl may contain from 1 to 40 carbon atoms.

Examples of hydrocarbyl groups include acyclic groups, as well as groups that combine one or more acyclic portions and one or more cyclic portions, which may be selected from carbocyclyl (e.g. cycloalkyl or cycloalkenyl) and heterocarbocyclyl groups (e.g. heterocycloalkyl or heterocycloalkenyl).

The term “alkyl” as used herein refers to a monovalent straight- or branched-chain alkyl moiety containing from 1 to 40 carbon atoms. Examples of alkyl groups include alkyl groups containing from 1 to 30 carbon atoms, from 1 to 20 carbon atoms, or from 1 to 8 carbon atoms. Unless specifically indicated otherwise, the term “alkyl” does not include optional substituents.

The term “alkenyl” as used herein refers to a monovalent straight- or branched-chain alkyl group containing from 2 to 40 carbon atoms and containing, in addition, at least one carbon-carbon double bond, of either E or Z configuration unless specified. Examples of alkenyl groups include alkenyl groups containing from 2 to 28 carbon atoms, from 3 to 18 carbon atoms, or from 4 to 12 carbon atoms.

The term “cycloalkyl” as used herein refers to a monovalent saturated aliphatic hydrocarbyl moiety containing from 3 to 40 carbon atoms and containing at least one ring, wherein said ring has at least 3 ring carbon atoms. The cycloalkyl groups mentioned herein may optionally have alkyl groups attached thereto. Examples of cycloalkyl groups include cycloalkyl groups containing from 3 to 16 carbon atoms, e.g. from 3 to 10 carbon atoms. Particular examples include cycloalkyl groups containing 3, 4, 5 or 6 ring carbon atoms. Examples of cycloalkyl groups include groups that are monocyclic, polycyclic (e.g. bicyclic) or bridged ring system. Examples of cycloalkyl groups include cyclopropyl, cyclobutyl, cyclopentyl, cyclohexyl and the like. “Cycloalkenyl” groups correspond to non-aromatic cycloalkyl groups containing at least one carbon-carbon double bond.

The term “heterocycloalkyl” as used herein is intended to refer to a cycloalkyl group described above wherein one or more of the carbon atoms, and any substituents attached thereto, is replaced with a heteroatom, preferably an oxygen atom (—O—), provided that the heteroatom is not bonded to another heteroatom in the ring. Heterocycloalkyl groups preferably include substituted furans and pyrans, particularly furanose and pyranose forms of sugars. “Heterocycloalkenyl” groups correspond to non-aromatic heterocycloalkyl groups containing at least one carbon-carbon double bond.

The structured emulsion of the present invention may comprise a polyhydroxy compound in an amount of from 1 to 55 wt. %, such as in an amount of from 10 to 40 wt. %, 15 to 35 wt. %, or from 16 to 30 wt. %, or from 18 to 28 wt. %, by weight of the structured emulsion. In other embodiments, the polyhydroxy compound of the structured emulsion is present in an amount of at least 11 wt. %, at least 12 wt. %, at least 13 wt. %, at least 14 wt. %, or at least 15 wt. %. In other embodiments, the polyhydroxy compound of the structured emulsion is present in an amount of less than 30 wt. %, less than 29 wt. %, less than 28 wt. %, less than 27 wt. %, or less than 26 wt. %.

The alpha gel phase that may form in the structured emulsions disclosed herein which include a polyhydroxy compound have been found to resist mesomorphic changes into the thermodynamically favourable beta gel phase (‘coagel’) particularly effectively. Without being bound by theory, the presence of a polyhydroxy compound in the structured emulsion is believed to enhance stability of the alpha-gel phase up to temperatures which substantially exceed the Krafft temperature and sub-alpha gel phase (at low storage temperatures) over longer periods than with conventional structured emulsions comprising lower amounts of, or none of, the polyhydroxy compound relative to the other essential components of the structured emulsion. The stabilising effect is believed to be due to the presence of multiple hydroxyl groups, some of which may adopt a vicinal configuration, and the particular steric interaction with the structured emulsion that results.

The presence of the polyhydroxy compound in the preferred structured emulsion is also believed to lead to the formation of lower than conventional oil droplet sizes, as observed for instance by microscope techniques or measured using laser diffraction. The inventors believe that the presence of the polyhydroxy compound results in a decreased surface tension of water which leads to a decrease in droplet size.

In preferred embodiments, the polyhydroxy compound may be selected from monosaccharides, sugar alcohols, disaccharides, oligosaccharides and polysaccharides, preferably monosaccharides, disaccharides and sugar alcohols. Monosaccharides and disaccharides are referred to herein as ‘sugar(s)’. Preferably, if the polyhydroxy compound is a polysaccharide, it has a molecular weight of 500 g/mol or less.

The structured emulsion may comprise sugar and/or a sugar alcohol. In some embodiments, the structured emulsion contains sugar, optionally in combination with a sugar alcohol. Sugar may be utilized in the structured emulsion in the absence of sugar alcohol, as part of preparing a ‘clean label’ food product. Therefore, in some embodiments, the structured emulsion comprises sugar and is free of sugar alcohol. Reference to “free of sugar alcohol” is intended to mean less than 50 ppm of sugar alcohol, preferably less than 10 ppm, more preferably less than 5 ppm of sugar alcohol is present in the structured emulsion.

Monosaccharides used in the present invention may be selected from glucose, fructose, xylose, ribose, galactose, mannose, arabinose, allulose, tagatose and combinations thereof. The sugar alcohols may be selected from ethylene glycol, glycerol, erythritol, sorbitol, xylitol, maltitol, mannitol, lactitol and combinations thereof. The disaccharides may be selected from sucrose, maltose, trehalose, lactose, lactulose, isomaltulose, kojibiose, nigerose, cellobiose, gentiobiose, sophorose and combinations thereof; the oligosaccharides may be selected from oligofructose, galacto oligosaccharides, raffinose, and combinations thereof; and the polysaccharides may be selected from dextrins.

Preferably, the sugar is selected from sucrose, glucose, galactose, fructose, trehalose, xylose, mannose and combinations thereof. Most preferably, the sugar component comprises a reducing sugar. Without being bound by theory, it is believed that these sugars contribute to the Maillard reaction and thus are preferred.

In some embodiments, the structured emulsion comprises sugar in an amount of from 1 to 55 wt. %, such as in an amount of from 10 to 40 wt. %, 15 to 35 wt. %, or from 16 to 30 wt. %, or from 18 to 28 wt. %. In other embodiments, the structured emulsion contains sugar in an amount of at least 11 wt. %, at least 12 wt. %, at least 13 wt. %, at least 14 wt. %, or at least 15 wt. %. In other embodiments, the structured emulsion contains sugar in an amount of less than 30 wt. %, less than 29 wt. %, less than 28 wt. %, less than 27 wt. %, or less than 26 wt. %.

The term ‘sugar alcohol’ used herein is intended to refer to any polyol having at least two carbon atoms which is derived or derivable from the hydrogenation or fermentation of one or more sugars described hereinbefore. Suitable sugar alcohols for use in the present invention include ethylene glycol, glycerol, erythritol, sorbitol, arabitol, xylitol, ribitol, maltitol, mannitol, lactitol, sorbitol and combinations thereof. Preferably, the sugar alcohol is selected from erythritol, sorbitol, arabitol, xylitol, ribitol, maltitol, mannitol, lactitol, sorbitol and combinations thereof. More preferably, the sugar alcohol is selected from glycerol and sorbitol. In some embodiments, the structured emulsion comprises sugar alcohol in an amount of from 1 to 55 wt. %, such as in an amount of from 10 to 40 wt. %, 15 to 35 wt. %, or from 16 to 30 wt. %, or from 18 to 28 wt. %. In other embodiments, the structured emulsion contains sugar alcohol in an amount of at least 11 wt. %, at least 12 wt. %, at least 13 wt. %, at least 14 wt. %, or at least 15 wt. %. In other embodiments, the structured emulsion contains sugar alcohol in an amount of less than 30 wt. %, less than 29 wt. %, less than 28 wt. %, less than 27 wt. %, or less than 26 wt. %.

As will be appreciated by the skilled person, the polyhydroxy compound is preferentially soluble/miscible in the aqueous phase of the emulsion, as opposed to the oil phase. Therefore, as discussed in more detail hereinbelow, the polyhydroxy compound may be incorporated into an aqueous phase as the emulsion is prepared.

### Emulsifier

The structured emulsion may comprise an emulsifier in an amount of from 1 to 8 wt. %. In preferred embodiments, the amount of emulsifier in the structured emulsion of the invention is from 2 to 7 wt. %, more preferably in an amount of from 3 to 5 wt. % or from 4 to 6 wt. %.

The emulsifier utilised is capable of self-assembly to form the structured emulsions required in the present invention when combined with the oil and water phases, and optionally a polyhydroxy compound, of the emulsion. When forming oil-in-water emulsions, the emulsifier component has been found to preferentially adopt either an alpha or sub-alpha crystalline form, thereby forming an alpha or sub-alpha gel mesophase having the characteristic lamellar structure, which typically includes a hexagonally packed lamellar structure, where water layers are structured between emulsifier bilayers.

The emulsifier component may be non-ionic, ionic, or a combination of non-ionic and ionic emulsifiers. In preferred embodiments, the emulsifier component comprises a non-ionic emulsifier, preferably in combination with an ionic emulsifier.

Suitable non-ionic emulsifiers include monoglycerides, propylene glycol fatty acid esters, polyglycerol fatty acid esters and combinations thereof. In preferred embodiments, the non-ionic emulsifier comprises at least one monoglyceride. In particularly preferred embodiments, the non-ionic emulsifier consists essentially of one or more monoglycerides.

Monoglycerides employed as non-ionic emulsifiers may be either 1- or 2-monoglycerides, and may be saturated or unsaturated, preferably saturated. In some embodiments, the monoglycerides include a fatty acid chain length of from 12 to 22 carbon atoms, preferably from 14 to 22 carbon atoms, more preferably from 16 to 20 carbon atoms, for example 16 or 18 carbon atoms. Specific examples of monoglycerides include glycerol monopalmitate and glycerol monostearate. Examples of commercial sources of monoglycerides suitable for use in the present invention include DIMODAN® distilled monoglycerides derived from sunflower, rapeseed, palm and/or soya bean oil, available from DuPont Danisco. Preferably, the monoglycerides do not originate from palm oil.

The propylene glycol fatty acid esters are mono- and diesters suitably derived from the esterification of propylene glycol with edible fats under alkaline conditions and at elevated temperature. The fatty acid derived moieties of the propylene glycol fatty acid esters may be monounsaturated, polyunsaturated or saturated, or a combination thereof. In preferred embodiments, the fatty acid derived moieties of the propylene glycol fatty acid esters are saturated. In some embodiments, the chain lengths of the fatty acid derived moieties are from 12 to 22 carbon atoms, preferably 14 to 22 carbon atoms, more preferably 16 to 20 carbon atoms, for example 16 or 18 carbon atoms. Particularly preferred propylene glycol fatty acid esters are propylene glycol monoesters of stearic acid, palmitic acid or blends thereof.

The polyglycerol fatty acid esters may comprise 2 to 10 glycerol repeat monomer units, preferably 2 to 6 glycerol repeat monomer units, more preferably 3 to 5 glycerol repeat monomer units, esterified with one or more saturated or unsaturated fatty acids. In some embodiments, the polyglycerol fatty acid ester is a polyglycerol monoester of a fatty acid.

The fatty acid derived moieties of the polyglycerol fatty acid esters may be monounsaturated, polyunsaturated or saturated, or a combination thereof. In preferred embodiments, the fatty acid derived moieties of the polyglycerol fatty acid esters are saturated. In some embodiments, the chain lengths of the fatty acid derived moieties are from 12 to 22 carbon atoms, preferably 14 to 22 carbon atoms, more preferably 16 to 20 carbon atoms, for example 16 or 18 carbon atoms. Particularly preferred polyglycerol fatty acid esters are polyglycerol monoesters of stearic or palmitic acid having 3 to 5 glycerol repeat monomer units and triglycerol diesters of stearic or palmitic acid.

In particularly preferred embodiments, the non-ionic emulsifier is glycerol monopalmitate, glycerol monostearate, or blends thereof.

Suitable ionic emulsifiers include acid esters of monoglycerides or diglycerides, fatty acids and metal salts thereof, anionic lactylated fatty acid salts and combinations thereof. In preferred embodiments, the ionic emulsifier for use in the present invention comprises an anionic lactylated fatty acid salt.

Acid esters of mono- and di-glycerides are suitably selected from mono- and di-glycerides esterified with short-chain naturally occurring carboxylic acids, typically derived from plants, such as acetic acid, citric acid, lactic acid, tartaric acid and combinations thereof. An example of an acid ester of diglyceride is glycerol lacto palmitate. Acetylated derivatives of some acid esters of mono- and diglycerides may be used, a particularly preferred examples of which are diacetyl tartaric acid esters of mono and diglycerides (DATEM). Monoglycerides for forming the corresponding acid ester thereof may be as described above. Diglycerides employed in forming the corresponding acid ester thereof may be either 1,2- or 1,3-diglycerides, preferably 1,3-diglycerides, and may be saturated or unsaturated, preferably saturated. In some embodiments, the diglycerides include fatty acid chain lengths each of from 12 to 22 carbon atoms, preferably from 14 to 22 carbon atoms, more preferably from 16 to 20 carbon atoms, for example 16 or 18 carbon atoms.

Fatty acids and metal salts thereof can also suitably act as ionic emulsifiers. Preferred examples of such fatty acids are saturated and preferably comprising from 14 to 24, more preferably from 16 to 18 carbon atoms in the fatty acid chain. Preferred examples of fatty acids include stearic and palmitic acid, as well as alkali metal salts thereof, preferably sodium salts thereof. Anionic lactylated fatty acid salts may be used as the ionic emulsifier and suitably include those derived from reaction of lactic acid with a fatty acid, preferably as described above, in the presence of sodium carbonate or sodium hydroxide. A particularly preferred example of an anionic lactylated fatty acid salt is sodium stearoyl lactylate (SSL).

In particularly preferred embodiments, the ionic surfactant is selected from stearic acid, sodium stearate, sodium palmitate, palmitic acid, sodium stearoyl lactylate (SSL), and a diacetyl tartaric acid ester of a monoglyceride (DATEM), and combinations thereof.

Combinations of non-ionic and ionic emulsifiers may be used in the structured emulsion. The combination of a non-ionic and ionic emulsifier may have additional benefits for forming the alpha/sub-alpha gel phase in the structured emulsion. A particularly preferred combination of non-ionic and ionic emulsifiers for use in the present invention includes at least one monoglyceride as described herein together with one or more of stearic acid, sodium stearate, sodium stearoyl lactylate (SSL), and diacetyl tartaric acid ester of monoglycerides (DATEM), most preferably at least one monoglyceride as described herein together with sodium stearoyl lactylate (SSL) or sodium stearate.

When employed in combination, it is preferred that the non-ionic emulsifier represents the major proportion of the emulsifier component (i.e. above 50 wt. % of the emulsifier component). In preferred embodiments, the weight ratio of the non-ionic emulsifier to ionic emulsifier is from 70:30 to 99:1, preferably from 75:25 to 95:5, more preferably from 80:20 to 90:10. Thus, in one illustrative example, the combination of non-ionic and ionic emulsifiers may be 80 to 90 wt. % of one or more monoglycerides together with 10 to 20 wt. % sodium stearoyl lactylate (SSL). In another illustrative example, the combination of non-ionic and ionic emulsifiers may be 80 to 95 wt. % of one or more monoglycerides together with 5 to 20 wt. % sodium stearate.

### Waxes

The meat-analogue composition may comprise one or more waxes. Preferably, the structured emulsion comprises at least one wax, which structured emulsion may or may not comprise a polyhydroxy compound as defined herein. The meat-analogue composition, preferably the structured emulsion, may comprise more than one wax.

The wax may include any edible agent which functions to provide structure to the emulsion, for example, to increase stress yield and elastic modulus, of the emulsion. Suitable waxes include edible waxes. Examples of suitable waxes include, but are not limited to, rice bran wax, carnauba wax, candelilla wax, sunflower wax, jojoba oil wax, corn oil wax, sugarcane wax, ouricury wax, retamo wax, paraffin wax and polyethylene wax. As will be appreciated, the selection of the wax will depend on the intended utility of the final product. Preferably, the structured emulsion comprises about 0.01-15% by weight of the selected wax, preferably about 0.5-10% by weight of wax, and more preferably about 2-10% by weight wax.

### Aqueous Continuous Phase

The structured emulsion preferably comprises from 12 to 40 wt. % water, preferably from 15 to 40 wt. %, more preferably from 15 to 35 wt. % water, most preferably from 15 to 25 wt. % water. As will be appreciated, the continuous aqueous phase of the structured emulsion incorporates all sources of water that have been employed in the preparation of the emulsion. Thus, in addition to water that is added during preparation of the emulsion, any water content of other components of the emulsion will contribute to the aqueous continuous phase and the total water content of the structured emulsion. For example, where a polyhydroxy compound is incorporated into the emulsion and the polyhydroxy compound is provided in the form of an aqueous solution before it is combined with the other components of the structured emulsion, the water content of the aqueous solution will make up the total water content of the structured emulsion once prepared. As will also be appreciated, the aqueous phase of the structured emulsion typically comprises additional ingredients that are preferentially water soluble/preferentially water miscible, relative to the oil phase of the structured emulsion.

Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

In preparing the structured emulsion, different sources of water may be relied upon in forming the aqueous phase, wherein each water source has a different conductivity, and individually contributes to the conductivity of the aqueous phase as a whole. Preferably, the aqueous phase of the structured emulsion has a conductivity of less than 500 μS/cm, preferably less than 100 μS/cm, more preferably less than 10 μS/cm.

The aqueous continuous phase of the structured emulsion may be formed substantially of demineralized or distilled water together with the sugar/sugar alcohol component of the emulsion. The polarity of the polyhydroxy compound means that, if present, this component of the structured emulsion typically preferentially partition into the aqueous phase, as opposed to the oil phase.

Other ingredients that may be included in the aqueous phase include salt, flavourings, colourings and/or stabilizers, although these are by no means essential. In embodiments, stabilizers are preferably included in the structured emulsion. It is believed that the presence of stabilizers may improve the texture of the food product, in particular reducing tackiness or stickiness. As described hereinbefore, the structured emulsion has been found to be tolerant of salt. Salt has historically been used as means to lower water activity of food products for extending shelf-life. Nevertheless, it is preferred that the amount of salt that is used is minimised, since salt is not required by the present invention to achieve long microbial shelf life. Preferably, the amount of salt present in the structured emulsion is less than 2.0 wt. %, more preferably less than 1.5 wt. %. The amount of salt may be increased in order to achieve a structured emulsion of the required stability, as described hereinabove.

In some embodiments, the structured emulsion includes an aqueous continuous phase which has an alkaline pH. In preferred embodiments, the aqueous phase of the structured emulsion which comprises the water component has a pH of at least 8.0, for example from 8.0 to 10, preferably from 8.0 to 9.5, more preferably from 8.0 to 9.0. For example, the presence of sodium stearate or sodium palmitate in the structured emulsion, both of which are capable of moving between the oil and water phases, have been found to give rise to a pH of from 8.0 to 9.0 in the aqueous phase. It is particularly surprising that the structured emulsion disclosed herein, can include an aqueous phase with alkaline pH, whilst still achieving the long microbial shelf life observed. In conventional systems, employing known preservation techniques it is typical to use acidic pH values optionally in combination with a preserving agent, such as potassium sorbate. The present invention can thus obviate the use of such traditional systems for controlling microbial growth. The naturally low water activity (a_{w}) of the structured emulsions disclosed herein also contributes substantially to the favourable long-term stability of the structured emulsion, particularly in terms of long-term microbial shelf-life.

The a_{w} value is calculated by dividing the partial vapour pressure of water in a substance by the standard state partial vapour pressure of water. In the field of food science, the standard state is most often defined as the partial vapour pressure of pure water at the same temperature at which the partial vapour pressure of water in the substance was measured. Using this definition, pure distilled water has a water activity of exactly 1. The a_{w} value of a substance may be determined by placing a sample in a container which is then sealed and, after equilibrium is reached, determining the relative humidity above the sample. An example of a suitable apparatus for determining a_{w} is the Aqualab 4TE benchtop water activity meter by Meter group.

The structured emulsions may have an a_{w} of less than 0.90, which is generally considered to be below the threshold at which bacterial growth and reproduction occurs. Therefore, the low water activity exhibited by the structured emulsions contributes to the long term stability, particularly against microbial growth, of the structured emulsions. Thus, in some embodiments, the structured emulsion has an a_{w} of 0.90 or below, preferably an a_{w} below 0.90. In other embodiments, the structured emulsion retains an a_{w} of 0.90 or below, preferably an a_{w} of below 0.90, after storage for 28 days, even after storage for 55 days, at a temperature of less than 30° C.

The structured emulsions may nevertheless be formulated with higher and still benefit from other advantages of the invention, as described herein. Thus, in some example, the a_{w} may be as high as 0.93, 0.92 or 0.91, for instance. Therefore, in some embodiments, the structured emulsion has an a_{w} of 0.93 or below, 0.92 or below, or 0.91 or below.

### Oil Phase

The structured emulsion may comprise from 25 to 70 wt. % oil, preferably from 35 to 65 wt. % oil, more preferably from 40 to 60 wt. % oil, most preferably 50 to 60 wt. % oil. It will of course be understood that other ranges such as 45 to 55 wt. % and 50 to 55 wt. % are also contemplated.

The oil phase of the structured emulsion may suitably be selected from any edible glyceride oil that is at least partially obtained from a natural source (for example, a plant, animal or fish/crustacean/algae source), and may be a combination of multiple oils. The oil may be selected from a vegetable oil, a marine oil, an animal oil and combinations thereof. Preferably, the oil comprises a vegetable oil. Preferably, the oil phase exists in a liquid form in the structured emulsion of the invention and therefore glyceride fats, particularly animal fats, that may be solid at room temperature (e.g at 20° C.) may be used in combination with other lower melting point oils to ensure that the oil phase remains liquid. Alternatively, such fats may be fractionated to isolate lower melting point fractions for use in the structured emulsion.

Vegetable oils include all plant, nut and seed oils. Examples of suitable vegetable oils which may be of use in the present invention include: açai oil, almond oil, beech oil, cashew oil, coconut oil, colza oil, corn oil, cottonseed oil, flaxseed oil, grapefruit seed oil, grape seed oil, hazelnut oil, hemp oil, lemon oil, macadamia oil, mustard oil, olive oil, orange oil, peanut oil, palm oil, palm kernel oil, pecan oil, pine nut oil, pistachio oil, poppyseed oil, rapeseed oil, rice bran oil, safflower oil, sesame oil, shea butter and its fractions (particularly shea olein), soybean oil, sunflower oil, walnut oil and wheat germ oil. Preferred, vegetable oils are those selected from corn oil, rapeseed oil, hazelnut oil, sunflower oil, safflower oil, soybean oil, peanut oil, olive oil, flaxseed oil, shea butter and its fractions (particularly shea olein) and rice bran oil.

Marine oils include oils derived from the tissues of oily fish or crustaceans (e.g. krill) as well as algae. Examples of suitable animal oils/fats include pig fat (lard), duck fat, goose fat, tallow, and butter. Nevertheless, given the particular application of the present invention to the preparation of vegetarian or vegan food products, it is generally preferred that the oil of the oil phase is a vegetable oil.

As described hereinbefore, a particular benefit of the present invention is that the use of oils and fats containing significant amounts of saturated and trans fatty acids may be avoided when making a meat-analogue composition.

### Oil/Water Ratio

In some preferred embodiments, oil/water weight ratio of the structured emulsion is at least 0.6, at least 0.8, at least 1.0, at least 1.4, at least 1.8, or at least 2.2. In other preferred embodiments, the oil/water weight ratio of the structured emulsion is from 0.6 to 5.8, more preferably from 1.0 to 5.0, even more preferably from 2.0 to 4.0, for example 3.0 to 4.0. In such preferred embodiments, it will be appreciated that the weight concentration of water in the structured emulsion may be lower relative to the oil component. This can be advantageous as it allows more of the water present in the meat-analogue composition to be available for hydration of other components of the composition, particularly for hydration of proteins, rather than for forming part of the structured emulsion itself.

As will be appreciated, preferred features of the meat-analogue composition described hereinabove may be combined with other preferred features to form particularly preferred embodiments of the invention, which, for example, include:

Embodiment A: a meat-analogue composition as described herein wherein the composition comprises: a) from 15 to 25 wt. % plant protein, b) from 40 to 60 wt. % water, c) from 5 to 10 wt. % carbohydrate.

Embodiment B: a meat-analogue composition as described herein, or according to Embodiment A, wherein:
the emulsifier component of the structured emulsion comprises a non-ionic emulsifier in combination with an ionic emulsifier,
the non-ionic emulsifier comprises at least one monoglyceride as described herein (for example, glycerol monopalmitate and glycerol monostearate); and
the ionic emulsifier is selected from acid esters of mono- and diglycerides, fatty acids and metal salts thereof, anionic lactylated fatty acid salts and combinations thereof (for example, stearic acid, sodium stearate, sodium stearoyl lactylate (SSL), and diacetyl tartaric acid ester of monoglycerides (DATEM)).

Embodiment C: a meat-analogue composition as described herein, or according to Embodiment A or Embodiment B, wherein:
the polyhydroxy compound of the structured emulsion is selected from monosaccharides, disaccharides and sugar alcohols (for example, sucrose, glucose, galactose, fructose, trehalose, xylose, and mannose).

Embodiment D: a meat-analogue composition as described herein, or according to Embodiments A to C, wherein the oil component of the structured emulsion comprises, or consists, of a vegetable oil, for example, where the vegetable oil is selected from corn oil, rapeseed oil, hazelnut oil, sunflower oil, safflower oil, soybean oil, peanut oil, olive oil, flaxseed oil, shea butter and its fractions (particularly shea olein) and rice bran oil.

Embodiment E: a meat-analogue composition as described herein, or according to any of Embodiments A to D, wherein the meat-analogue composition is prepared from a structured emulsion comprising, based on the weight of the structured emulsion:
i) from 3 to 6 wt. % (for example, 3 to 5 wt. % or 4 to 6 wt. %) emulsifier;
ii) from 15 to 35 wt. % (for example, 15 to 25 wt. %) water;
iii) from 40 to 60 wt. % (for example, 45 to 55 wt. % or 50 to 55 wt. %) oil; and
iv) from 16 to 30 wt. % (for example, 18 to 28 wt. %) of polyhydroxy compound.

Embodiment F: a meat-analogue composition as described herein, or according to any of Embodiments A to E, wherein the meat-analogue composition is prepared from a structured emulsion having an oil/water ratio from 1.0 to 5.0, preferably from 2.0 to 4.0, more preferably from 3.0 to 4.0.

### Food Products

The use of a structured emulsion in the manufacture of a meat-analogue composition according to the present invention has been found to provide desirable structure, texture and/or consistency to the meat-analogue composition. Thus, there is provided a meat-analogue food product prepared using the composition disclosed herein. The meat-analogue food product may be a minced or ground meat analogue having the form of a burger, sausage, nugget, meatball, or meatloaf, preferably a burger.

There is also provided a cooked or part-cooked food product prepared using the meat-analogue composition described herein.

In still a further aspect of the present invention, the present invention also provides a use of a structured emulsion as described herein as a component of a meat-analogue composition. Such use may be for reducing oil and/or water loss from the meat-analogue composition during cooking.

The properties of the meat-analogue composition or food products prepared using the composition may be measured by any suitable means. Properties of interest may include juiciness (and/or dryness), hardness, adhesiveness, springiness, cohesiveness, gumminess, chewiness and resilience. Such means include taste testers, which can provide feedback on properties of the composition or food product such as juiciness (or dryness), texture, chewiness and hardness. Typically, multiple testers will be asked to mark one or more properties of the composition or food product, such as on a scale from 1 to 5. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. Gumminess is defined as the product of hardness x cohesiveness. Chewiness is defined as the product of gumminess×springiness (hardness×cohesiveness×springiness). In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess.

Gumminess is defined as the product of hardness×cohesiveness and is a characteristic of semisolid foods with a low degree of hardness and a high degree of cohesiveness.

Chewiness is defined as the product of gumminess×springiness (which equals hardness×cohesiveness×springiness) and is therefore influenced by the change of any one of these parameters.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

### Preparation of the Meat-Analogue Composition

The meat-analogue composition of the present invention may be readily prepared by blending a structured emulsion as described herein with plant protein and any other components of the composition. In one aspect, there is provided a process for preparing a meat-analogue composition, said process comprising the step of: forming the meat-analogue composition by blending a plant protein with an oil-in-water structured emulsion characterised by having an ordered lamellar gel network. Optionally, further ingredients may be present. Water may be added to the composition if required at any stage during the process. The process may further comprise the step of: preparing the plant protein by providing a dry phase comprising plant protein and blending the dry phase with an amount of water, which precedes the step of forming the meat-analogue composition. This step may also include other ingredients which are in dry form, such that these dry ingredients are hydrated simultaneously with the plant protein. Additionally, and/or alternatively, any other dry ingredients may be hydrated separately from the plant protein in any combination. In embodiments which include TVPs, the TVP is preferably hydrated separately from any other dry ingredients. Without being bound by theory, this is believed to limit competition between the dry components for the water and ensure satisfactory hydration for all dry components present.

Thus, the present invention provides a process for preparing a meat-analogue composition, said process comprising the steps of: a) providing a dry phase comprising plant protein and optionally any other dry ingredients of the composition and blending the dry phase with an amount of water to form a mixture; b) forming the meat-analogue composition by blending the mixture formed in step a) with an oil-in-water structured emulsion characterised by having an ordered lamellar gel network. The oil-in-water structured emulsion may comprise a polyhydroxy compound. In embodiments, the plant protein may comprise TVPs. Preferably, dry ingredients other than the plant protein are hydrated separately from the plant protein. Examples of such dry ingredients include, but are not limited to, fibres, flavours, emulsifiers, gums, hydrocolloids, thickeners. In embodiments, the mixture of step a) comprising the hydrated plant protein and any other mixtures comprising hydrated dry ingredients are combined prior to step b). Without being bound by theory, it is believed that the hydration of dry ingredients prior to the addition of the structured emulsion (for example, in step a)) results in an optimal distribution of water in the product, resulting in a more stable meat-analogue composition.

The dry phase comprising plant protein used in the above process is not particularly limited. The plant protein is as described hereinabove. The term ‘dry phase’ is intended to mean that the phase comprising plant protein comprises less than 5 wt. % water, preferably less than 2 wt. % water, more preferably less than 1 wt. % water, even more preferably that it is substantially free from water. In other preferred embodiments, the a_{w} of the dry phase is 0.90 or lower, more preferably below 0.80. The dry phase comprising plant protein is typically provided in a substantially dehydrated state to reduce microbial growth as far as possible so as to extend shelf life.

The dry phase, which may comprise plant protein, may take any physical form before being blended with water, however typically it is in powder, granule or pelletized, strip or chunk form. The amount of water added to the dry phase is not particularly limited. Typically, an amount of water is added in order to bind the dry components into a paste or dough with which the structured emulsion may be readily blended. Preferably, the meat-analogue composition comprises from 35 to 70 wt. % water, preferably from 40 to 65 wt. % water, which includes the water contained in the structured emulsion. Therefore, the amount of water added to the dry phase is preferably calculated such that the total amount of water in the meat-analogue composition after the structured emulsion is added is within this range. Furthermore, water may be added to the composition even if a dry phase is not used such that the total amount of water in the meat-analogue composition after the structured emulsion is added is within this range.

The temperature of the water added is not particularly limited, so long as it does not materially impact the intended characteristics of the components (e.g. does not lead to protein denaturation or hydrolysis). In preferred embodiments, the water is below room temperature (i.e. below 20° C.). In particularly preferred embodiments, ice water is used. This is particularly preferred when water is added to the dry phase. The term “ice water” is defined herein as having a temperature of above 0° C. and below 6 C, preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose.

The blending of the dry phase with water may be performed for any duration of time. In embodiments, blending is performed until the dry phase and water are intimately mixed and typically until a paste or dough is formed. In embodiments in which TVPs are hydrated, blending is limited to a minimum so as not to overly disturb the fibrous structures. In embodiments this may be performed for a duration of from 1 minute to 30 minutes, preferably from 1 minutes to 10 minutes, more preferably from 5 seconds to 5 minutes.

Following blending of the dry phase and water, for example in step a), the mixture may be allowed to rest prior to the addition of the structured emulsion, for example in step b). This may ensure full hydration of the dry phase prior to addition of the structured emulsion. This rest may be performed under cold storage (thereby further controlling microbial growth), which has a temperature of from 0.5 to 15° C., preferably from 1 to 12° C., more preferably from 5 to 10° C. This rest may be performed for a duration of from 5 minutes to 5 hours, preferably from 5 minutes to 2 hours, more preferably from 5 minutes to 30 minutes.

The structured emulsion used in the method is as described herein and may be prepared by any suitable method, including those disclosed in WO 2005/107489 A1 (for example, at paragraphs [0050] to [0052], [0056], [0077] and [0078] thereof). As a result of the stability of the structured emulsion having an ordered lamellar gel network, the inventors have found that it is readily prepared by conventional techniques.

A suitable method for preparing the structured emulsion therefore involves separately preparing the oil and aqueous phases, separately heating the prepared oil and aqueous phases to elevated temperatures, preferably the same elevated temperature, combining and mixing the two phases at elevated temperature, before cooling to room temperature (e.g. 20° C.).

Typically, the polyhydroxy compound, if present, is dissolved in the aqueous phase and the emulsifier component is dissolved or dispersed in the oil phase. Furthermore, whilst a non-ionic emulsifier may be readily dispersed or dissolved in the oil phase, an ionic emulsifier may preferably be dispersed or dissolved in the aqueous phase. A person of skill in the art may readily identify the phase in which to dissolve or disperse the emulsifier component, as well as other optional additives.

Heating of the separate aqueous and oil phases may be by conventional methods and preferably to an elevated temperature of at least 40° C., more preferably at least 50° C., up to temperatures of preferably less than 90° C., more preferably less than 80° C. In preferred embodiments, the aqueous and oil phases are heated to a temperature of from 65 to 85° C., more preferably from 70 to 80° C., for example 75° C. It is not required that the oil and aqueous phases are heated to the same temperature.

As will be appreciated, the emulsifier component should be provided at a temperature which is above the Krafft temperature, as well as above the melting temperature of the emulsifier component, but below the lamellar to non-lamellar transition temperature of the emulsifier. For this reason, the oil-phase comprising the emulsifier component is preferably heated to greater than 65° C. and less than 80° C. In preferred embodiments, immediately after combining of the oil and aqueous phases, the Krafft temperature remains exceeded.

As the structured emulsion is an oil-in-water emulsion, the heated oil phase is typically added to the heated aqueous phase with stirring, for example for 1 to 60 minutes depending on the scale of the preparation. Preferably, addition of the oil phase is incremental, with simultaneous mixing of the combined phases using any conventional mixing apparatus. On a small scale, this may be achieved using a hand mixer (for example the Dynamic MD95 hand mixer). On an industrial scale, standard emulsifying equipment may be used (examples of which include the SPX Emulsifying System, type ERS, and IKA Standard Production Plant). The shear rate of mixing is not believed to be particularly influential to the formation of the structured emulsion of the invention. Nevertheless, inline high shear mixers (IKA Ultra Turrax), homogenisers (SPX APV) or ultrasonic emulsification (Hielscher) may be used in preparation of the structured emulsion.

Following complete addition of the oil phase to the aqueous phase, the mixture is allowed to cool to room temperature (e.g. 20° C.). Although the application of refrigeration or external cooling is not a requirement, increasing the rate of cooling can be advantages in preserving the properties of the structured emulsion and delaying loss of the alpha gel phase after formation.

Thus, in some preferred embodiments, refrigeration or external cooling is applied following formation of the structured emulsion at elevated temperature. Rates of cooling achievable with refrigeration or external cooling may be, for instance, higher than 10° C. per minute, preferably higher than 50° C. per minute. Preferably, where refrigeration or external cooling is applied, this is done to reduce the temperature of the structured emulsion after formation to 50° C. or below, preferably 40° C. or below, more preferably 35° C. or below, depending on the temperature at which the structured emulsion is formed. Refrigeration or external cooling may be applied until the prevailing environmental temperature condition is achieved. Alternatively, the application of refrigeration or external cooling may be stopped and further cooling may arise as a result of the prevailing environmental temperature condition (with a correspondingly slower cooling rate). Refrigeration or external cooling may be achieved using conventional equipment, for example plate heat exchangers, tube coolers, or scraped surface heat exchangers, preferably tube coolers.

Thus, the process for preparing a meat-analogue composition may further comprise preparing the oil-in-water structured emulsion by: i) providing an oil phase comprising an emulsifier component and an aqueous phase; ii) separately heating the oil phase and the aqueous phase to form heated oil and aqueous phases; iii) adding the heated oil phase to the heated aqueous phase to form a mixture; and iv) allowing the mixture to cool to form the oil-in-water structured emulsion.

In embodiments, the aqueous phase comprises a polyhydroxy compound as described herein.

The structured emulsions utilised in the present invention exhibit a level of stability that has been found to make them particularly useful for integrating into the preparation of meat-analogue compositions according to the invention. The structured emulsions are able to resist mesomorphic changes, even under exposure to elevated temperatures. This stability has been found to be enhanced yet further where a polyhydroxy compound is incorporated into the structured emulsion (e.g. by incorporating the polyhydroxy compound in the aqueous phase of the emulsion).

The inventors have found that structured emulsions that may be used in accordance with the present invention can be provided with relatively low droplet size. Typically, where there is a lack of emulsion stability, smaller oil droplets would be expected to undergo coalescence, such that the amount of emulsifier is at least adequate to provide an individual droplet with sufficient stability. Without being bound by theory, it is believed that the ability to form smaller droplet sizes may contribute to, or derive from, the stability of the structured emulsion utilised in accordance with the present invention, which stability may be enhanced in the presence of a polyhydroxy compound, as mentioned above. This oil droplet size is believed to also be particularly beneficial for providing advantageous texture and consistency to food products comprising it.

Thus, the structured emulsion may be prepared with oil droplets having a unimodal size distribution and/or an equivalent surface area mean diameter (the so called “Sauter mean diameter” or “D(3.2)”) of from 0.1 to 10 μm. It is possible that the optional inclusion of a polyhydroxy compound may help reinforce the structural properties of the emulsion leading to enhanced stability meaning that smaller droplet sizes are achievable which are resistant to coalescence. In particular, the inventors believe that the presence of the polyhydroxy compound may decrease the surface tension of water leading to a decrease in droplet size, for the same energy input. These features make structured emulsions comprising a polyhydroxy compound particularly suitable for use in the present invention.

Thus, in preferred embodiments, oil droplets of the structured emulsion used in accordance with the present invention have a surface area mean diameter of less than 5 μm, for example from 0.1 to 5 μm, from 0.1 to 4 μm, from 0.1 to 3 μm, from 0.1 to 2 μm, or from 0.1 to 1.5 μm, as may be determined by Dynamic Light Scattering (DLS), microscope techniques (for example, Scanning Electron Microscope (SEM) techniques) or laser diffraction techniques. A suitable apparatus for performing laser diffraction includes the Malvern Mastersizer X by Malvern Instruments. Preferably, the oil droplets have an equivalent surface area mean diameter of from 0.1 to 3.0 μm, preferably from 0.1 to 1.5 μm, as measured by dynamic light scattering (DLS).

Preparation of the meat-analogue composition may also comprise the step of adding further ingredients to the composition. These ingredients may be added at any stage in the preparation of the meat-analogue composition. In embodiments, further ingredients are added after the addition of the structured emulsion, for example after step b). Preferably, dry ingredients are hydrated prior to addition to the structured emulsion. In embodiments, dry ingredients are hydrated with any dry plant protein, such as in step a), prior to the addition of the structured emulsion. Such ingredients may include one or more of carbohydrates, polysaccharides, modified polysaccharides, hydrocolloids, gums, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators, as disclosed in more detail herein. The addition of these ingredients may be performed by blending, mixing or any suitable means.

Once the meat-analogue composition has been prepared, this may be formed into a food product. This may include the step of forming the meat-analogue composition into the desired shape. The shape and size of the resulting food product is not particularly limited. Examples of shaped food products which can be made from the meat-analogue composition according to the present invention include burgers, sausages, nuggets, meatballs and mince.

Any suitable method may be used to shape the meat-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat.

The process of preparing a meat-analogue composition may further comprise cooking or part-cooking the composition, which may have been formed into a food product. Cooking may comprise boiling, baking, frying and/or microwaving. In preferred embodiments, cooking is at sufficient temperature such that the Maillard reaction may occur (for example, above 80° C. and up to 180° C., preferably from 130° C. to 170° C.). The Maillard reaction is useful for desirable browning of the food product.

In another aspect, the present invention provides a meat-analogue composition preparable, or prepared, by the processes disclosed herein.

In a further aspect, the present invention provides a structured emulsion for use as a component of a meat-analogue composition, preferably for use in reducing oil and/or water loss from the meat-analogue composition during cooking.

The present invention will now be described by way of reference to the Figure and Examples, in which:

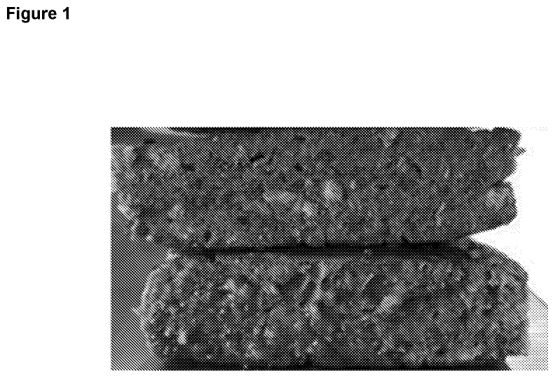

FIG. 1 shows a photograph of the cross section of burgers both not in accordance with the invention (Comparative Example 1, top) and in accordance with the invention (Example 2, bottom) after frying.

### EXAMPLES

### General Method for Preparation of Structured Emulsions

The following procedure was used for the preparation of structured emulsions, Emulsion A, Emulsion B and Emulsion C:
1. The oil phase was prepared by blending the components of the oil phase shown in Table 1 and heating the mixture to 75° C. for at least 3 minutes;
2. The water phase was also prepared by blending the components (where applicable) of the water phase shown in Table 1 and heating the mixture to 75° C. for at least 3 minutes;
3. The oil phase was slowly added to the aqueous phase over the course of two minutes at 75° C. with simultaneous mixing;
4. The resulting emulsion was allowed to cool naturally to room temperature (20° C.).

As can be seen from Table 1, Emulsion B differs from Emulsion A and Emulsion C in that is does not comprise a polyhydroxy compound. Emulsion C differs from Emulsion A as it comprises a different polyhydroxy compound and in a smaller amount.

TABLE 1

| | Emulsion A | Emulsion B | Emulsion C |
|---|---|---|---|
| Oil phase | | | |
| High oleic sunflower oil (g) | 60 | 60 | 60 |
| Emulsifier* (g) | 5 | 5 | 5 |
| Water phase | | | |
| Polyhydroxy compound (g) | 27.3** | | 5*** |
| tap water (g) | 7.7 | | 30 |
| deionized water (g) | | 35 | |

*The emulsifier used was Dimodan ® HR 85 S6 corresponding to distilled monoglyceride emulsifier comprising 6% by weight of sodium stearate.
**The polyhydroxy compound used in this case was a sugar composition, namely Raftisweet ® S67/100, corresponding to an aqueous solution of nutritive saccharides obtained from sugar comprising 67% sucrose.
***The polyhydroxy compound used in this case was dextrose.

### General Method for Preparation of Plant-Based Burgers Using Plant-Protein Composition A

The following procedure was used for the preparation of the plant-based burgers of the following examples:
1. Plant-Protein Composition A⁺, was blended with ice water (1-3° C.) according to the quantities shown in Table 2 and further hydrated for at least 30 minutes in cold storage (5° C.);

³⁰ Plant-Protein Composition A referred to above is a dry/dehydrated powdered plant protein composition comprising pea protein, texturized vegetable protein, thickener (methyl cellulose), salt, spices, vegetable extracts, spice extracts, glucose syrup, flavourings, colourings, as well as fat, carbohydrate and fibre.
2. Either Emulsion A, Emulsion B or high oleic sunflower oil according to the quantities shown in Table 2 were added at room temperature to the hydrated Plant Protein Mix A and the resulting dough blended for about 1 min;
3. The dough was rested in a fridge (operating at a temperature of 5° C.) for at least 20 minutes;
4. Burgers (diameter 8 cm; height 2 cm; weight 100 g) were made from this dough and stored in the fridge (operating at a temperature of 5° C.) prior to cooking;
5. Burgers were cooked by heating on a frying pan with sunflower oil (5 g) for 6 minutes (4 times 1.5 minutes).

The compositions of the burgers of Comparative Example 1, Example 1 and Example 2 prepared according to the above general method are shown below in Table 2.

TABLE 2

| | Comparative | | |
|---|---|---|---|
| | Example 1 | Example 1 | Example 2 |
| Ice water (g) | 598 | 530 | 530 |
| Plant-Protein | 274 | 274 | 274 |
| Composition A (g) | | | |
| High oleic sunflower | 128 | | |
| oil (g) | | | |
| Emulsion A (g) | | 196 | |
| Emulsion B (g) | | | 196 |
| Total (g) | 1000 | 1000 | 1000 |
| % Moisture (wt. %) | 59.8 | 56.4 | 59.9 |
| % Fat (wt. %) | 13.5 | 13.4 | 13.4 |

The burgers according to Comparative Example 1, Example 1 and Example 2 have the same mass and similar moisture and fat contents, allowing their properties to be compared. The burgers made in Comparative Example 1 are not according to the present invention, as a structured emulsion was not used.

### General Method for Preparation of Plant-Based Burgers Using Texturised Proteins

The following procedure was used for the preparation of the plant-based burgers of the following examples:
1. The texturised proteins⁺⁺ were hydrated with cold water (5° C.) according to the quantities shown in Table 3 and further hydrated for at least 30 minutes in cold storage (5° C.); ⁺⁺The texturised proteins referred to above are a blend of textured pea proteins (protein content minimum 70%; format: strips) and textured fava proteins (protein content minimum 60%; format: chunks).
2. All other ingredients in powder form (stabilizer blend⁺⁺⁺ and flavours) were mixed and hydrated with ice water (1-3° C.) by blending for at least 1 minute, following which they were stored in fridge for at least 30 minutes; ⁺⁺⁺The stabiliser blend referred to above is a blend of pea proteins (protein content minimum 83%; format: powder), pea fiber and methylcellulose.
3. The hydrated texturized proteins were chopped for 20 seconds at low speed;
4. The ingredients from steps 2 and 3, Emulsion C or sunflower oil and coconut oil, and any further ingredients (e.g. colours, fats, oils) according to the quantities shown in Table 3 were combined at room temperature and the resulting dough blended for about 2 mins;
5. The dough was rested in a fridge (operating at a temperature from 2 to 5° C.) for at least 30 minutes;
6. Burgers (diameter 8 cm; height 2 cm; weight 100 g) were made from this dough and stored in the fridge (operating at a temperature from 2 to 5° C.) prior to cooking;
7. Burgers were cooked by heating on a frying pan with sunflower oil (5 g) for 6 minutes (4 times 1.5 minutes).

The compositions of the burgers of Comparative Example 2 and Example 3 prepared according to the above method are shown below in Table 3.

TABLE 3

| | Comparative | |
|---|---|---|
| | Example 2 | Example 3 |
| Cold water (5° C.) (g) | 174 | 174 |
| Texturized proteins (g) | 70 | 70 |
| Coconut oil (melted) (g) | 24 | 0 |
| Sunflower oil (g) | 26 | 0 |
| Emulsion C (g) | 0 | 77 |
| Stabilizer blend (g) | 25.8 | 25.8 |
| Ice water (1-3° C.) (g) | 96.2 | 75 |
| Flavours (g) | 4 | 4 |
| Colours (g) | 4.4 | 4.4 |

The burgers according to Comparative Example 2 and Example 3 have a similar mass and similar moisture and fat contents, allowing their properties to be compared. The burgers made in Comparative Example 2 are not according to the present invention, as a structured emulsion was not used.

### Assessment of Burger Properties Before Cooking

Texture profile analysis (TPA) was used to determine the hardness, adhesiveness, springiness, cohesiveness, gumminess and chewiness of the burgers of the examples, a market reference vegan burger and a 100% beef burger—which parameters are described in more detail in Table 4 below. TPA was performed on a TA.XT₂ machine (by Stable Micro Systems) fitted with a 5 kg load cell and a 25 mm Dia Cylinder Aluminium Probe (P/25). The machine was programmed to run with the following settings: pre-test speed: 1 mm/s; test speed: 5 mm/s; post-test speed: 5 mm/s; compression depth: 5 mm; time between cycles: 5 s; trigger type: automatic on 5 g; data acquisition rate: 200 pps. The test material was compressed two times in a reciprocating motion, mimicking the chewing movement in the mouth. A Force versus Time (and/or distance) graph was obtained, from which the desired information was obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

TABLE 4

| | |
|---|---|
| Springiness | Related to the height that the food recovers during the time that |
| | elapses between the end of the first bite and the start of the second |
| | bite |
| Cohesiveness | Defined as the ratio of the positive force area during the second |
| | compression to that during the first compression |
| | May be measured as the rate at which the material disintegrates under |
| | mechanical action. |
| Hardness | Defined as the maximum peak force during the first compression cycle |
| | (first bite) and has often been substituted by the term firmness |
| Gumminess | Defined as the product of hardness × cohesiveness. Gumminess is a |
| | characteristic of semisolid foods with a low degree of hardness and a |
| | high degree of cohesiveness |
| Chewiness | Defined as the product of gumminess × springiness (which equals |
| | hardness × cohesiveness × springiness) and is therefore influenced by |
| | the change of any one of these parameters. |
| Adhesiveness | Defined as the negative force area for the first bite and represents the |
| | work required to overcome the attractive forces between the surface |
| | of a food and the surface of other materials with which the food comes |
| | into contact, i.e. the total force necessary to pull the compression |
| | plunger away from the sample. |

Dough workability was measured on a scale of 0 to 5, corresponding to low to good workability respectively.

The measured properties of the dough and burgers formed in the examples, a market reference vegan burger and a 100% beef burger before cooking are shown in Tables 5 to 7.

TABLE 5

| | Comparative | | |
|---|---|---|---|
| | Example 1 | Example 1 | Example 2 |
| Dough | 3 (oily) | 4 | 3.5 (bit sticky) |
| workability | | | |

TABLE 6

| Property Before | Comparative | | |
|---|---|---|---|
| Cooking | Example 1 | Example 1 | Example 2 |
| Weight (g) | 99.56 | 98.87 | 99.11 |
| Diameter (cm) | 8.1 | 8.0 | 8.0 |
| Height (cm) | 2.2 | 2.2 | 2.3 |
| Hardness (g) | 757.96 | 1206.01 | 815.13 |
| Adhesiveness | −37.31 | −31.01 | −140.68 |
| (g · sec) | | | |
| Springiness | 0.78 | 0.83 | 1.00 |
| Cohesiveness | 0.60 | 0.62 | 0.65 |
| Gumminess | 456.62 | 743.17 | 525.47 |
| Chewiness | 358.13 | 619.31 | 522.89 |

TABLE 7

| | | | Market | |
|---|---|---|---|---|
| | | | reference | |
| Property Before | Comparative | | vegan | 100% Beef |
| Cooking | Example 2 | Example 3 | burger | burger |
| Weight (g) | 98.37 | 98.37 | 112.6 | 139 |
| Diameter (cm) | 7.9 | 8.0 | 9.1 | 8.3 |
| Height (cm) | 2.0 | 2.1 | 1.8 | 2.7 |
| Hardness (g) | 1073.08 | 692.68 | 465.44 | 1275.63 |
| Adhesiveness | −29.7 | −66.6 | −14.63 | −14.45 |
| (g · sec) | | | | |
| Springiness | 0.82 | 0.84 | 0.71 | 0.89 |
| Cohesiveness | 0.48 | 0.57 | 0.55 | 0.74 |
| Gumminess | 604.93 | 450.43 | 297.24 | 1041.85 |
| Chewiness | 498.18 | 379.77 | 211.28 | 929.49 |

Preferred values for the burgers before cooking are as follows: hardness from 400 to 5000 g, preferably from 400 to 1500 g; springiness from 0.1 to 1, preferably from 0.5 to 1; cohesiveness from 0.1 to 1, preferably from 0.4 to 0.8; gumminess from 200 to 4000, preferably from 300 to 1100; and chewiness from 100 to 4000, preferably 300 to 1000. As can be seen in Tables 6 and 7, the burgers according to the present invention fall within these ranges.

Additionally, it can be seen that the burgers of Example 1, which use an emulsion with a high content of polyhydroxy compound, exhibit improved workability (lower adhesiveness and higher hardness before frying) when compared to those of Example 2, which use an emulsion which does not include a polyhydroxy compound.

### Properties of the Burgers of the Examples After Frying

The properties of the burgers formed in Comparative Example 1, Example 1, Example 2, Comparative Example 2, Example 3, a market reference vegan burger and a 100% beef burger after frying are shown in Tables 8 and 9. The hardness, adhesiveness, springiness, cohesiveness, gumminess and chewiness of the burgers were measured by TPA using the same method as described above. Juiciness was determined by a panel of testers. In particular, a panel of 5 tasters blindly tested the burgers formed in each of the examples after frying. The tasters were asked to provide a juiciness score out of 5; 0 being the least juicy and 5 being the most juicy. The average score was determined.

TABLE 8

| | Comparative | Example | Example |
|---|---|---|---|
| Property After Frying | Example 1 | 1 | 2 |
| Weight (g) | 81.32 | 87.05 | 87.13 |
| Weight loss (g) | 18.24 | 11.82 | 11.98 |
| Moisture loss (g) | 14.94 | 10.21 | 10.37 |
| Other (mainly oil) loss (g) | 3.3 | 1.61 | 1.61 |
| Yield (%) | 82 | 88 | 88 |
| Diameter (cm) | 7.3 | 7.5 | 7.5 |
| Height (cm) | 2.4 | 2.4 | 2.5 |
| Hardness (g) | 1710.17 | 1920.48 | 1394.40 |
| Adhesiveness (g · sec) | −13.83 | −20.66 | −22.01 |
| Springiness | 0.80 | 0.86 | 0.89 |
| Cohesiveness | 0.78 | 0.82 | 0.80 |
| Gumminess | 1329.70 | 1566.32 | 1110.62 |
| Chewiness | 1062.45 | 1351.34 | 985.40 |
| Juiciness (average out of 5) | 2.5 | 3.5 | 4.2 |

TABLE 9

| | | | Market | |
|---|---|---|---|---|
| | | | reference | 100% |
| Property | Comparative | | vegan | Beef |
| After Frying | Example 2 | Example 3 | burger | burger |
| Weight (g) | 87.10 | 87.28 | 90.2 | 129.35 |
| Weight loss (g) | 11.27 | 11.09 | 22.4 | 9.65 |
| Moisture loss (g) | 10.73 | 11.04 | 19.9 | 9.65 |
| Other (mainly oil) | 0.54 | 0.05 | 2.5 | 0.05 |
| loss (g) | | | | |
| Yield (%) | 89 | 89 | 80 | 93 |
| Diameter (cm) | 7.3 | 7.7 | 8.5 | 7.4 |
| Height (cm) | 2.1 | 2.1 | 1.7 | 2.9 |
| Hardness (g) | 588.04 | 881.91 | 1180.12 | 1331.94 |
| Adhesiveness (g · sec) | −1.05 | −7.76 | −11.78 | −1.68 |
| Springiness | 0.99 | 0.84 | 0.83 | 0.99 |
| Cohesiveness | 0.78 | 0.80 | 0.80 | 0.88 |
| Gumminess | 505.66 | 760.19 | 979.68 | 1205.81 |
| Chewiness | 500.70 | 640.95 | 816.40 | 1193.99 |
| Juiciness | 4 | 5 | 2.5 | 5 |
| (average out of 5) | | | | |

Desirable values for the above parameters after cooking of the burgers are as follows: a) hardness from 500 to 5000, preferably from 700 to 1500 g; b) springiness from 0.1 to 1, preferably from 0.5 to 1; c) cohesiveness from 0.1 to 1, preferably from 0.5 to 1; d) gumminess from 300 to 4000, preferably from 500 to 1500; and/or e) chewiness from 300 to 4000, preferably 500 to 1500. As can be seen in Tables 8 and 9, burgers according to the present invention fall within all of the preferred ranges for the above parameters.

Tables 8 and 9 also demonstrate that the burgers comprising a relatively small amount of polyhydroxy compound in Example 3 exhibit the highest juiciness rating. This is preferable to the use of no polyhydroxy compound in Example 2, and a larger amount of polyhydroxy compound in Example 1. This suggests that structured emulsions which are of intermediate stability result in the best juiciness. Without being bound by theory, such a structured emulsion is believed to be stable during storage, prior to cooking but breaks down during cooking.

As shown in Tables 8 and 9, burgers according to the present invention exhibit textural properties comparable to those of the market reference vegan burger and the 100% beef burger.

These results demonstrate that the burgers formed in Example 1 and Example 2, which include a structured emulsion, result in less weight loss (both from oil and from moisture) and less shrinkage (their diameter and height reduced less) upon cooking when compared to the burger of Comparative Example 1 which does not include a structured emulsion. Similarly, the burger formed in Example 3, which includes the structured emulsion, resulted in less weight loss than the burger of Comparative Example 2 which does not include the structured emulsion.

The burgers of Example 1 and Example 2 were also found by taste testers to be juicier than those of Comparative Example 1. Overall, the burger of Comparative Example 1 was generally described as more compact, tough to eat and dryer than the other burgers. These conclusions are consistent with the observation that less moisture and less oil were lost from the burgers of Examples 1 and 2, which would be expected to result in a less dry, hence juicier, burger. Similarly, the burger formed in Example 3, was found by taste testers to be juicier than the burger of Comparative Example 2. Overall, the burger of Example 3 was described as the most tender and juicy.

These tasting comments are also consistent with visual assessment of the cooked burgers shown in FIG. 1, showing Comparative Example 1 (top), and Example 1 (bottom). The burger of Comparative Example 1 is clearly more compact, whilst the burger of Example 1 appears to be the most moist.

### Calorimetry Assessment of the Burgers Before and After Cooking

Using colorimetry (BYK instruments calorimeter), burgers from Comparative Example 1, Example 1 and Example 2 were assessed for their lightness (L*), redness (a*) and yellowness (b*) according to the CIE system. Results before and after cooking are shown in Table 10 below.

TABLE 10

| | | |
|---|---|---|
| Comparative | | |
| Example 1 | Example 1 | Example 2 |

Before frying

| | | | |
|---|---|---|---|
| L* | 34.55 | 51.47 | 47.79 |
| a* | 31.59 | 26.22 | 29.02 |
| b* | 28.73 | 26.19 | 29.42 |

After frying

| | | | |
|---|---|---|---|
| L* | 29.84 | 31.79 | 31.52 |
| a* | 33.78 | 33.01 | 35.26 |
| b* | 30.57 | 34.06 | 35.34 |

For uncooked burgers, desirable values are as follows: L* from 36 to 58; a* from 14 to 29; and b* from 12 to 30.
For cooked burgers, preferred values are as follows: L* from 24 to 40; a* from 9 to 36; and b* from 12 to 36.

It was found that, before cooking, the burger from Comparative Example 1 had a high a value and a low L* value making it appear more red than the other burgers. The burger from Example 1 had the highest L* and lowest a* and b* values and thus appeared more pink. Following cooking, the colour differences between the burgers observed before cooking reduced and all three values (L*, a* and b*) became much more similar between the four burgers.

### Plant-Based Burgers with Texturized Soy Protein

The previously described General method for preparation of structured emulsions was used for the preparation of structured emulsions, Emulsion D and Emulsion E. As can be seen from Table 11, Emulsion E differs from Emulsion D as it comprises a different polyhydroxy compound and in a smaller amount. The reduced polyhydroxy compound in Emulsion E is compensated by water and oil.

TABLE 11

| | Emulsion D | Emulsion E |
|---|---|---|
| Oil phase | | |
| Rapeseed oil | 60 | 65 |
| Emulsifier* | 5 | 5 |
| Water phase | | |
| De-ionized water | 16.7 | 25 |
| Polyhydroxy compound | 18.3** | 5*** |

*The emulsifier used was Dimodan ® HR 85 S6 corresponding to distilled monoglyceride emulsifier comprising 6% by weight of sodium stearate.
**The polyhydroxy compound used in this case was sucrose.
***The polyhydroxy compound used in this case was dextrose.

### General Method for Preparation of Plant-Based Burgers Using Texturized Soy Protein

The following procedure was used for the preparation of the plant-based burgers of the three following examples:
1. All ingredients in powder form (stabilizer blend*, flavors) and the texturized soy protein** were mixed. *The stabiliser blend referred to above was a blend of modified starches and hydrocolloids from Ingredion, RD 1020.**The texturized soy protein referred to above had a protein content minimum of 69% and a format of granules.
2. The colors were diluted in the cold water according to the quantities shown in Table 12, and blended with the ingredients from step 1 for six minutes for hydration.
3. Emulsion D or Emulsion E or rapeseed oil according to the quantities shown in Table 12 was combined with the ingredients from step 2 and the resulting dough was blended for another 2 minutes.
4. The dough was packed in a container and rested in a freezer (operating at a temperature of −18° C. to −22° C.) for approximately 10-15 minutes, so that the dough was slightly firm to facilitate the forming of the burgers.
5. Burgers (diameter 8 cm; height 2 cm; weight 100 g) were made from this dough and stored in the freezer (operating at a temperature of −18° C. to −22° C.) for at least 24 hours.
6. Burgers were cooked by heating on a grill plate with rapeseed oil (5 g) for 12 minutes (8 times 1.5 minutes).

The compositions of the burgers of Comparative Example 3, Example 4 and Example 5 prepared according to the above general method are shown below in Table 12.

TABLE 12

| | Comparative | | |
|---|---|---|---|
| | Example 3 | Example 4 | Example 5 |
| Cold water (g) | 1218.75 | 1090.29 | 1040.18 |
| Rapeseed oil (g) | 500.00 | | |
| Emulsion D (g) | | 769.23 | |
| Emulsion E (g) | | | 714.29 |
| Texturized soy protein (g) | 475 | 475 | 475 |
| Stabilizer blend (g) | 175 | 175 | 175 |
| Flavors (g) | 118.75 | 118.75 | 118.75 |
| Colors (g) | 12.5 | 12.5 | 12.5 |

The burgers according to Comparative Example 3, Example 4 and Example 5 have a similar mass and similar moisture and fat contents, allowing their properties to be compared. The burgers made in Comparative Example 3 are not according to the present invention, as a structured emulsion was not used.

### Assessment of Burger Properties Before Cooking

Texture profile analysis (TPA) was used according to the method described in previous examples using a TA.XTplus machine (Stable Micro Systems) fitted with a 36 mm Dia Cylinder Aluminium Probe (P/36 R). Hardness, springiness, cohesiveness, gumminess and chewiness of the burgers of the Comparative Example 3, Example 4 and Example 5 were determined.

The measured properties of the dough and burgers formed in Comparative Example 3, Example 4 and Example 5 before cooking are shown in Table 13.

TABLE 13

| Property | Comparative | | |
|---|---|---|---|
| Before Cooking | Example 3 | Example 4 | Example 5 |
| Weight (g) | 98.1 | 101.4 | 100.6 |
| Diameter mm) | 78.0 | 77.6 | 77.3 |
| Height (mm) | 23.3 | 24.2 | 24.8 |
| Hardness (g) | 1521.58 | 4872.63 | 2684.94 |
| Springinesss | 0.79 | 0.71 | 0.68 |
| Cohesiveness | 0.70 | 0.54 | 0.56 |
| Gumminess | 1060.31 | 1451.14 | 1147.09 |
| Chewiness | 836.52 Poor | 1024.20 Good | 780.31 Good |
| Dough workability | (loosing oil) | | |

Preferred values for the burgers before cooking are described in previous examples. As can be seen in Table 13, the burgers according to the present invention fall within these ranges.

Additionally, it can be seen that the burgers of Example 4 and Example 5, which use emulsions containing polyhydroxy compounds, show improved workability when compared to those of Comparative Example 3, which do not use a structured emulsion.

### Properties of the Burgers of the Examples After Cooking

The properties of the burgers formed in Comparative Example 3, Example 4 and Example 5 after frying are shown in Table 14. The hardness, springiness, cohesiveness, gumminess and chewiness of the burgers were measured by TPA using the same method as described above.

Juice-per-cooked-mass (JCM %) was determined by compressing the cooked burgers in an Aeropress (Model A80 by Aerobie) using a load force of 7 kg for 5 min. Prior to compression, the burgers were chopped with 6 parallel and 6 perpendicular cuts. The weight of the extracted juice was recorded and, by dividing it by the weight of the cooked burger, Juice-per-cooked-mass (JCM) was calculated.

TABLE 14

| Property | Comparative | | |
|---|---|---|---|
| After Frying | Example 3 | Example 4 | Example 5 |
| Weight (g) | 83.4 | 90.4 | 88.6 |
| Weight loss (g) | 14.7 | 11.1 | 12.1 |
| Moisture loss (g) | 11.7 | 9.9 | 10.6 |
| Other (mainly oil) loss (g) | 2.9 | 1.2 | 1.5 |
| Yield (%) | 85 | 89 | 88 |
| Diameter (mm) | 72.5 | 74.8 | 75.15 |
| Height (mm) | 21.8 | 22.4 | 23.3 |
| Hardness (g) | 5654.02 | 2445.12 | 3137.24 |
| Springinesss | 0.87 | 0.70 | 0.76 |
| Cohesiveness | 0.79 | 0.61 | 0.68 |
| Gumminess | 4440.65 | 1479.14 | 2145.28 |
| Chewiness | 3875.48 | 1040.41 | 1627.13 |
| Juice-per-cooked-mass (%) | 4.0 | 5.8 | 6.2 |

Desirable TPA values for the burgers after cooking are described in previous examples. As can be seen in Table 14, the burgers according to the present invention fall within these ranges.

Additionally, Table 14 demonstrates that the burgers comprising a relatively small amount of polyhydroxy compound in Example 5 exhibit a higher Juice-per-cooked-mass than the burgers comprising a larger amount of polyhydroxy compound in Example 4. This result is consistent with the observation in previous examples, that Example 3, comprising a relatively small amount of polyhydroxy compound, showed higher Juiciness than Example 2, comprising a larger amount of polyhydroxy compound. Both results support the suggestion that structured emulsions of intermediate stability result in the best juiciness.

Furthermore, the results in Table 14 demonstrate that the burgers formed in Example 4 and Example 5, which include a structured emulsion, result in less weight loss (both from oil and moisture) and less shrinkage (their diameter and height reduced less) upon cooking when compared to the burger of Comparative Example 3, which does not include a structured emulsion. These results are in line with observations made in aforementioned examples, comparing Example 1 and Example 2, which include structured emulsions, with Comparative Example 1, not using a structured emulsion, and comparing Example 3 and Comparative Example 2, respectively.

1. A meat-analogue composition comprising an oil-in-water structured emulsion and plant protein; wherein said structured emulsion has an ordered lamellar gel network.

2. A meat-analogue composition according to claim 1, wherein the composition comprises 5 to 30 wt. % plant protein.

3. A meat-analogue composition according to claim 1, wherein the composition comprises 35 to 70 wt. % water.

4. A meat-analogue composition according to claim 1, wherein the composition comprises at least 0.01 wt. % carbohydrate.

5. A meat-analogue composition according to claim 4, wherein the carbohydrate comprises starch, flour, edible fibre, or combinations thereof.

6. A meat-analogue composition according to claim 1, wherein the plant protein is selected from the group consisting of algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof.

7. A meat-analogue composition according to claim 1, wherein the composition further comprises one or more additional components selected from: i) polysaccharides and/or modified polysaccharides; ii) hydrocolloids; and iii) gums.

8. A meat-analogue composition according to claim 1, wherein the structured emulsion comprises a non-ionic emulsifier.

9. A meat-analogue composition according to claim 8, wherein the non-ionic emulsifier is selected from the group consisting of monoglycerides, propylene glycol fatty acid esters, polyglycerol fatty acid esters and combinations thereof.

10. A meat-analogue composition according to claim 1. wherein the structured emulsion comprises an ionic emulsifier selected from the group consisting of acid esters of mono- and diglycerides, fatty acids and metal salts thereof, anionic lactylated fatty acid salts and combinations thereof.

11. A meat-analogue composition according to claim 10, wherein the ionic emulsifier is selected from the group consisting of stearic acid, sodium stearate, sodium palmitate, palmitic acid, sodium stearoyl lactylate (SSL), a diacetyl tartaric acid ester of a monoglyceride (DATEM), and combinations thereof.

12. A meat-analogue composition according to claim 1, wherein the structured emulsion comprises a non-ionic emulsifier and an ionic emulsifier.

13. A meat-analogue composition according to claim 12, wherein the structured emulsion comprises an ionic emulsifier selected from stearic acid, sodium stearate and sodium stearoyl lactylate and a non-ionic emulsifier comprising a monoglyceride.

14. A meat-analogue composition according to claim 1, wherein the structured emulsion comprises a polyhydroxy compound with a molecular weight of 500 g/mol or less.

15. A meat-analogue composition according to claim 14, wherein the polyhydroxy compound of the structured emulsion is selected from the group consisting of sugars, sugar alcohols, disaccharides, oligosaccharides and polysaccharides.

16. A meat-analogue composition according to claim 15, wherein the sugars are selected from the group consisting of glucose, fructose, xylose, ribose, galactose, mannose, arabinose, allulose, tagatose and combinations thereof; the sugar alcohols are selected from the group consisting of ethylene glycol, glycerol, erythritol, sorbitol, xylitol, maltitol, mannitol, lactitol and combinations thereof; the disaccharides are selected from the group consisting of sucrose, maltose, trehalose, lactose, lactulose, isomaltulose, kojibiose, nigerose, cellobiose, gentiobiose, sophorose and combinations thereof; the oligosaccharides are selected from the group consisting of oligofructose, galacto oligosaccharides, raffinose, and combinations thereof; and the polysaccharides are selected from dextrins.

17. A meat-analogue composition according to claim 1, wherein the structured emulsion comprises an amino acid.

18. A meat-analogue composition according to claim 1, wherein the oil of the structured emulsion comprises a vegetable oil selected from the group consisting of açai oil, almond oil, beech oil, cashew oil, coconut oil, colza oil, corn oil, cottonseed oil, flaxseed oil, grapefruit seed oil, grape seed oil, hazelnut oil, hemp oil, lemon oil, macadamia oil, mustard oil, olive oil, orange oil, peanut oil, palm oil, palm kernel oil, pecan oil, pine nut oil, pistachio oil, poppyseed oil, rapeseed oil, rice bran oil, safflower oil, sesame oil, shea butter and its fractions, soybean oil, sunflower oil, walnut oil and wheat germ oil.

19. A meat-analogue composition according to claim 1, wherein the structured emulsion comprises a wax.

20. A meat-analogue composition according to claim 1, further comprising one or more of milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fiber, flavour components, colourants, thickening and gelling agents, egg powder, enzymes, gluten, vitamins, preservatives, sweeteners, oxidising agents, reducing agents, anti-oxidants, and acidity regulators.

21. A meat-analogue food product prepared using the composition according to claim 1.

22. A meat-analogue food product according to claim 21, wherein the food product is a minced or ground meat analogue having the form of a burger, sausage, nugget, meatball, or meatloaf.

23. A meat-analogue food product according to claim 21 which is cooked or part-cooked.

24. A process for preparing a meat-analogue composition, said process comprising the step of: forming the meat-analogue composition by blending a plant protein with an oil-in-water structured emulsion having an ordered lamellar gel network.

25. A process according to claim 24, wherein the process further comprises the step of: preparing the plant protein by providing a dry phase comprising plant protein and blending the dry phase with an amount of water.

26. A process according to claim 24, wherein the process further comprises preparing the oil-in-water structured emulsion by: i) providing an oil phase comprising an emulsifier component and an aqueous phase; and ii) separately heating the oil phase and the aqueous phase to form heated oil and aqueous phases; iii) adding the heated oil phase to the heated aqueous phase to form a mixture; and iv) allowing the mixture to cool to form the oil-in-water structured emulsion.

27. A process according to claim 26, wherein the aqueous phase comprises a polyhydroxy compound with a molecular weight of 500 g/mol or less.

28. A process according to claim 24, wherein the oil-in-water structured emulsion comprises, based on the weight of the structured emulsion, the following:
i) from 1 to 8 wt. % emulsifier;
ii) from 12 to 40 wt. % water; and
iii) from 25 to 70 wt. % oil.

29. A process according to claim 28, wherein the oil-in-water structured emulsion comprises, based on the weight of the structured emulsion: iv) from 1 to 55 wt. % of polyhydroxy compound with a molecular weight of 500 g/mol or less.

30. A process according to claim 28, wherein the emulsifier is present in an amount of from 2 to 7 wt. %.

31. A process according to claim 28, wherein the oil to water weight ratio is from 1.0 to 5.0.

32. A process according to claim 29, wherein the polyhydroxy compound is present in an amount from 10 to 40 wt. %.

33. A process according to claim 28, wherein the oil-in-water structured emulsion comprises, based on the weight of the structured emulsion, 0.01-15% wax.

34. A process according to claim 24, wherein the structured emulsion comprises oil droplets having an equivalent surface area mean diameter of from 0.1 to 3.0 μm, as measured by dynamic light scattering (DLS).

35. A process according to claim 24, further comprising cooking or part-cooking the composition.

36. A meat-analogue composition preparable, or prepared, by the process of claim 24.

37. A structured emulsion as defined in claim 1, wherein the structured emulsion reduces oil and/or water loss from a meat-analogue composition during cooking.
